(19) United States
(12) Patent Application Publication
(10) Pub. No.: US 2018/0052699 A1
(43) Pub. Date: Feb. 22, 2018

(54) Generating Computer Executable Instructions

(71) Applicant: MASTERCARD INTERNATIONAL INCORPORATED, Purchase, NY (US)

(72) Inventors: Srinivas M. Gummididala, Hyderabad (IN); Pranav Pathak, Pune (IN); Vikram Pappula, Pune (IN)

(21) Appl. No.: 15/668,250

(22) Filed: Aug. 3, 2017

(30) Foreign Application Priority Data
Aug. 16, 2016 (SG) 10201606821T

(51) Int. Cl. G06F 9/455; G06F 9/44

(52) U.S. Cl. CPC G06F 9/45512; G06F 9/4445; G06F 8/30

(57) ABSTRACT

There is provided a method and apparatus for generating computer executable instructions to allow computer interaction with a graphical user interface. The method and system provide a mechanism to allow users to easily generate computer executable instructions in the form of scripts. Thus, unskilled users can readily define scripts without requiring specific programming expertise.

### CROSS-REFERENCE TO RELATED APPLICATION

This application claims the benefit of and priority to Singapore Patent Application No. 10201606821T filed Aug. 16, 2016. The entire disclosure of the above application is incorporated herein by reference.

### FIELD

The present disclosure relates to a method and apparatus for generating and executing computer executable instructions to allow computer interaction with a graphical user interface.

### BACKGROUND

This section provides background information related to the present disclosure which is not necessarily prior art.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Scripts are programs in the form of computer executable instructions that can be executed in a run-time environment in order to automate tasks that are typically executed one-by-one by a human operator. For example, scripts can be used to allow interaction with user interfaces to be automated. Examples of this occur where a computer is used in order to access remote services via a user interface. In such a situation, the user is typically required to interact with the user interface to access the service by providing commands via appropriate interface elements, such as entering information in text fields, selecting particular input buttons, or the like. A script is a sequence of instructions that causes a computer system to act in a corresponding manner, to thereby provide automated access to the services.

The creation of such scripts typically requires knowledge of programming operations. In particular, this requires individuals creating scripts to be familiar with the necessary code instructions and be able to provide these in an appropriate sequence to cause the necessary interactions to occur. This makes it difficult for individuals with no programming experience to create scripts. Nevertheless, the ability to create scripts can represent a significant benefit to individuals, allowing them to automate readily performed tasks.

### SUMMARY

This section provides a general summary of the disclosure, and is not a comprehensive disclosure of its full scope or all of its features. Aspects and embodiments of the disclosure are set out in the accompanying claims.

In a first aspect, there is provided a method for generating computer executable instructions to allow computer interaction with a graphical user interface, the method including, in a computer system: displaying a reference interface, the reference interface being a reference instance of the graphical user interface; capturing an image of a selected region of the reference interface; recording a sequence of one or more user interactions with the reference interface based on a relative position of each user interaction with respect to the selected region; and, generating computer executable instructions defining the sequence of user interactions in accordance with the respective relative position of each user interaction.

The method can include: determining the selected region in accordance with user input commands; determining a selected region position indicative of a position of the selected region; determining the relative position of each user interaction at least partially in accordance with the selected region position; determining a user interaction with the user interface in accordance with user input commands; determining a user interaction position indicative of a position of the user interaction on the user interface; determining the relative position of each user interaction at least partially in accordance with the user interaction position; and determining a relative position of each user interaction based on a user interaction position and a selected region position.

The method can also include: capturing a plurality of images, each image being of a respective selected region; recording a plurality of sequences of one or more user interactions, the user interactions of each sequence being recorded based on a relative position of the user interactions with respect to a respective one of the selected regions; determining an image code indicative of the captured image; and associating the image code with the computer executable instructions. Preferably, converting the image to the image code is carried out using an encoding algorithm. The image code can include text with at least one associated with and derived from the image. The image code can also include text, determined using OCR techniques.

The method can also include: determining at least one display attribute; and, generating the executable instructions at least partially in accordance with the display attribute.

It is preferable that the reference interface is rendered by a software application at least partially in accordance with data received from a remote computer system. It is also preferable that the reference interface is rendered by a first software application executed by the computer system whereby the method is performed using a second software application executed by the computer system. The second software application can display a control user interface, the method being performed at least in part using input commands received via the control user interface.

The method can be performed at least in part using a JAVA runtime application, and the reference interface can be rendered by a web browser. The method can also be performed using python libraries to performed image recognition.

In a second aspect, there is provided an apparatus for generating computer executable instructions to allow computer interaction with a graphical user interface, the apparatus including a computer system that: displays a reference interface; captures an image of a selected region of the reference interface; records a sequence of one or more user interactions with the reference interface based on a relative position of each user interaction with respect to the selected region; and, generates computer executable instructions defining the sequence of user interactions in accordance with the respective relative position of each user interaction.

It is preferable that the computer system includes: a display that displays the user interaction; and components for generating computer executable instructions to allow computer interaction with a graphical user interface.

There is also provided a method for computer interaction with a graphical user interface, the method including, in a computer system operating in accordance with computer executable instructions: accessing the user interface; identifying a region of the graphical user interface corresponding to a selected region of a reference interface at least in part using a captured image of the selected region and image recognition techniques; and, performing a sequence of one or more computer interactions with the graphical user interface in accordance with computer executable instructions, the computer executable instructions defining a sequence of one or more user interactions recorded based on a relative position of each user interaction with respect to the selected region of the reference interface, each computer interaction being performed relative to the identified region using the respective relative position of a corresponding user interaction.

The method can include identifying the region of the graphical user interface by: comparing the graphical user interface to an image code indicative of the captured image; and, identifying the region in accordance with results of the comparison.

The method can also include: converting the graphical user interface into interface codes; comparing the interface codes to the image code; and, identifying the region in accordance with results of the comparison. The comparing of the interface codes and the image code can be by using pattern matching techniques. In addition, the converting of the user interface into interface codes can be by using an encoding algorithm.

It is preferable that the interface codes include text with at least one associated with and derived from the graphical user interface. The code can include text determined using OCR techniques.

In addition, the method can include: determining a region position indicative of a position of the region; determining an interaction position using the region position and the relative position; determining at least one display attribute; determining the interaction position at least partially in accordance with the display attribute; identifying a plurality of regions, each region corresponding to a respective selected region; and performing a sequence of one or more user interactions relative to each of the plurality of regions.

It is preferable that the graphical user interface is rendered by a software application at least partially in accordance with data received from a remote computer system. It is also preferable that the graphical user interface is rendered by a first software application executed by the computer system and wherein the method is performed using a second software application executed by the computer system.

The method can be performed at least in part using a JAVA runtime application and using python libraries to performed image recognition. It is preferable that the graphical user interface is rendered by a web browser.

In another aspect, there is provided an apparatus for computer interaction with a graphical user interface, the apparatus including a computer system that operates in accordance with computer executable instructions to: access the user interface; identify a region of the graphical user interface corresponding to a selected region of a reference interface at least in part using a captured image of the selected region and image recognition techniques; and, perform a sequence of one or more computer interactions with the graphical user interface in accordance with computer executable instructions, the computer executable instructions defining a sequence of one or more user interactions recorded based on a relative position of each user interaction with respect to the selected region of the reference interface, each computer interaction being performed relative to the identified region using the respective relative position of a corresponding user interaction.

There is also provided a method for allowing computer interaction with a graphical user interface, the method including, in a computer system: (a) generating executable instructions by: (i) displaying a reference interface, the reference interface being a reference instance of the graphical user interface; (ii) capturing an image of a selected region of the reference interface; (iii) recording a sequence of one or more user interactions with the reference interface based on a relative position of each user interaction with respect to the selected region; and, (iv) generating computer executable instructions defining the sequence of user interactions in accordance with the respective relative position of each user interaction; and, (b) executing the executable instructions to interact with the graphical user interface by: (i) accessing the user interface; (ii) identifying a region of the graphical user interface corresponding to a selected region of a reference interface at least in part using a captured image of the selected region and image recognition techniques; and, (iii) performing a sequence of one or more computer interactions with the graphical user interface in accordance with computer executable instructions, the computer executable instructions defining a sequence of one or more user interactions recorded based on a relative position of each user interaction with respect to the selected region of the reference interface, each computer interaction being performed relative to the identified region using the respective relative position of a corresponding user interaction.

In a final aspect, there is provided an apparatus for allowing computer interaction with a graphical user interface, the apparatus including a computer system that: (a) generates executable instructions by: (i) displaying a reference interface, the reference interface being a reference instance of the graphical user interface; (ii) capturing an image of a selected region of the reference interface; (iii) recording a sequence of one or more user interactions with the reference interface based on a relative position of each user interaction with respect to the selected region; and, (iv) generating computer executable instructions defining the sequence of user interactions in accordance with the respective relative position of each user interaction; and, (b) executes the executable instructions to interact with the graphical user interface by: (i) accessing the user interface; (ii) identifying a region of the graphical user interface corresponding to a selected region of a reference interface at least in part using a captured image of the selected region and image recognition techniques; and, (iii) performing a sequence of one or more computer interactions with the graphical user interface in accordance with computer executable instructions, the computer executable instructions defining a sequence of one or more user interactions recorded based on a relative position of each user interaction with respect to the selected region of the reference interface, each computer interaction being performed relative to the identified region using the respective relative position of a corresponding user interaction.

It will be appreciated that the broad forms of the disclosure and their respective features can be used in conjunction, interchangeably and/or independently, and reference to separate broad forms is not intended to be limiting.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. An example of the present disclosure will now be described with reference to the accompanying drawings, in which:

FIG. 1 is a flow chart of an example of a process for generating and executing computer executable instructions to allow computer interaction with a graphical user interface;

FIG. 2 is a schematic diagram of an example of a distributed network architecture;

FIG. 3 is a schematic diagram of an example of a processing system;

FIG. 4 is a schematic diagram of an example of a computer system;

FIGS. 5A to 5C are a flow chart of a specific example of a process for generating computer executable instructions;

FIGS. 6A to 6D are schematic diagrams of examples of user interfaces during generation of computer executable instructions; and

FIG. 7 is a flow chart of an example of the process for executing computer executable instructions.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

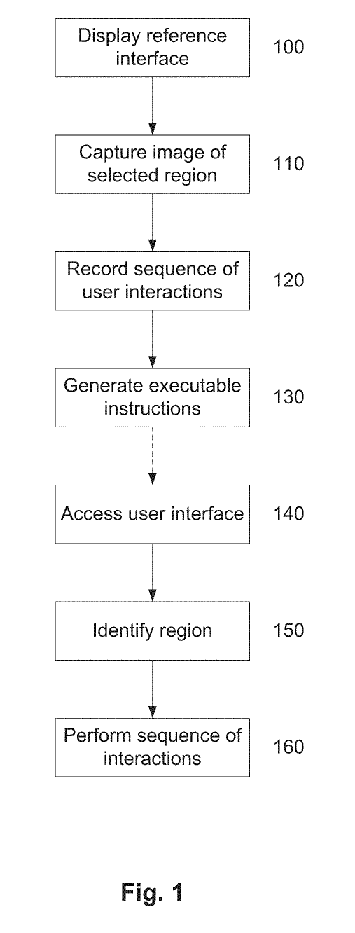

An example of a process for generating and then separately executing computer executable instructions to allow computer interaction with a graphical user interface will now be described with reference to FIG. 1.

For the purpose of this example, it is assumed that the processes performed, at least in part, used one or more computer systems which may optionally form part of a network architecture, with the computer system being connected to one or more other computer systems. The computer system can be of any appropriate form and could include a server, personal computer, client device, such as a mobile phone, portable computer, or the like, as will be described in more detail below.

For the purpose of illustration, throughout the following description the term “reference interface” is used to refer to a reference instance of a graphical user interface that is displayed during a process of generating computer executable instructions. This terminology is used to distinguish from an instance of the same graphical user interface which is subsequently used for computer interaction when executing the generated computer instructions. This difference in terminology is used for the purpose of ease of explanation only and is not intended to be limiting.

In this example, at step 100, a computer system is used to display the reference interface. This can be achieved in any appropriate manner, but typically involves utilising applications software installed on the computer system, which causes the user interface to be displayed. The user interface is typically rendered by the software application and may be generated based on locally stored data and/or data received from a remote processing system, such as a server, or the like. In one example, the graphical user interface, and hence the reference interface, are in the form of web pages served by a web server and displayed utilising a web browser, although this is not necessarily the case and is merely for illustrative purposes.

At step 110, the computer system captures an image of a selected region of the reference interface. This can be achieved in any appropriate manner, such as by having a user select a region of the reference interface utilising an input device, such as a mouse, pointer, or the like. Alternatively, this could be achieved in an automated or semi-automated fashion, for example, by having the computer system identify particular features and/or elements in the reference interface using pattern matching, identification of particular tags in an http file, or the like.

At step 120, a sequence of one or more user interactions with the reference interface are recorded based on a relative position of each user interaction with respect to the selected region. Thus, for example, the user may select one or more input buttons, enter text in appropriate text fields, or perform any other form of interaction. The inputs made, such as the keystrokes, pointer selections, or the like, are recorded, together with an indication of a position of these interactions, which is measured relative to the position of the selected region.

At step 130, the computer system generates computer executable instructions defining a sequence of interactions corresponding to the user interactions and based on the respective relative position of each user interaction. Thus, the computer system can generate instructions that reflect the particular sequence of user interactions entered by the user based on the position of these relative to the selected region.

Having generated the instructions, these can subsequently be executed either by the same or by another computer system.

In this regard, at step 140 the computer system executing the instructions accesses the graphical user interface, which is another instance of the same graphical user interface used in generating the computer executable instructions. The computer system need not display the user interface and may simply receive the data required in order to substantiate the interface.

At step 150, the computer system identifies a region of the graphical user interface corresponding to the selected region of the reference interface. This is performed, at least in part, using the captured image of the selected region and image recognition techniques. Thus, the computer system performs image recognition in order to identify a region of the current user interface that corresponds to the captured image of the selected region of the reference interface.

At step 160, the computer system can then perform a sequence of one or more computer interactions with the graphical user interface in accordance with the computer executed instructions. In particular, the computer system can perform the sequence of interactions that correspond to the one or more user interactions recorded during the process of generating the executable instructions. The interactions are performed relative to the region based on the relative position of each corresponding user interaction with respect to the corresponding selected region.

Accordingly, the above described process operates by allowing users to capture images of part of a user interface. The position of user interactions relative to the captured image is then used to generate instructions. When the instructions are executed, image recognition techniques are utilised in order to identify a corresponding part of the user interface. Computer interactions can then be performed automatically at the same relative position with respect to the identified region of the user interface.

It will be appreciated that the above described process allows users with little or no programming experience to generate scripts for automating interaction with user interfaces. By performing this process through capturing of images on the user interface, this allows user interactions to be recorded relative to the captured image so that when user interfaces are subsequently displayed, variations in the layout of the interface will not impact on the execution of the interactions. For example, if the user captures an image of a region they are then able to interact with interface elements, such as text fields, input buttons, or the like, whose relative position with respect to the captured image is invariant. This means when the user interface is subsequently generated for automated interaction, a corresponding part of the interface can be identified based on the captured image so that interactions are performed successfully.

A number of further features will now be described.

In one example, the method includes determining the selected region in accordance with user input commands. This could be achieved in any appropriate manner, but typically includes having the user interact with the user interface to designate a respective region, for example, by dragging a pointer to highlight a particular region of the interface. Once the selected region has been identified, the method can include determining a selected region position indicative of a position of the selected region and determining the relative position of each user interaction, at least partially in accordance with the selected region position. Thus, the selected region position could correspond to a particular part of the selected region, such as a top left hand corner of the image, or a position of a particular graphical or user interface element within the image.

The computer system typically determines a user interaction with the user interface in accordance with user input commands, determines a user interaction position indicative of the user interaction on the user interface and then determines the relative position of each user interaction at least partially in accordance with the user interaction position. Thus, an absolute position of the user interaction is determined, before a relative position of the interaction is determined with respect to an absolute position of the region.

In one example, the process involves capturing a plurality of images, with each image being of a respective selected region. For each image, a sequence of one or more user interactions can then be recorded, with each sequence of user interactions being recorded based on the relative position of the user interactions with respect to a respective one of selected regions. By capturing multiple images from within the user interface, this can help ensure that interaction positions are determined relative to a local part of the user interface whose position is substantially invariant relative to the interactions, irrespective of the layout, thereby ensuring that positions of interactions are accurately recorded. This can avoid changes in layout resulting in incorrect positioning of inputs, as might arise, for example, if the user interface is displayed using a different screen resolution, aspect ratio, zoom level, or the like.

Additionally, the use of different image regions and associated sequences of interactions allows each respective sequence to be treated as an individual executable instruction module. Different modules can then be combined in different ways, thereby vastly increasing the functionality that can be implemented.

The method typically includes determining an image code indicative of the captured image and associating the image code with the computer executable instructions. The image code can be determined in any appropriate manner and can include converting the image to an image code using an encoding algorithm. In one particular example, the image code includes text with at least one associated with and derived from the image, for example, this could be achieved by determining text using OCR (Optical Character Recognition) techniques, or the like.

In one example, the process includes determining at least one display attribute and generating the executable instructions at least partially in accordance with the display attribute. For example, the display attribute could include a screen resolution, aspect ratio, and/or zoom level associated with the displayed reference interface, using this to generate the instructions, for example, by normalising the relative positions so that these can be interpreted for different scalings, resolutions, or the like.

In one example, the reference interface is rendered by a software application at least partially in accordance with data received from a remote computer system. In one particular example, the reference interface is rendered by a first software application executed by the computer system and the method is performed by, and in particular the instructions are generated by, a second software application executed by the computer system. In this example, the second software application can display a control user interface, with the method being performed at least in part using input commands received via the control user interface. Thus, the control user interface can be used to control the process of generating the instructions and, in particular, the capturing of images and recording of user interactions. This can be achieved utilising any appropriate technique, but in one example, the method is performed at least in part using a JAVA run-time application with the reference interface being rendered by a web browser and python libraries being used to perform image recognition, although this is not essential and other configurations can be used.

When executing instructions, the computer system typically compares the graphical user interface to an image code indicative of a captured image and then identifies the region in accordance with the results of the comparison. This can be achieved in any appropriate manner, but typically this involves converting the graphical user interface into multiple interface codes, comparing the interface codes to the image code, and then identifying the region in accordance with the results of the comparison. Whilst the comparison can be an exact match comparison, more typically the comparison is performed using pattern matching techniques, for example, allowing non-identical matches to be determined.

The process of converting the graphical user interface into interface codes typically involves converting the user interface to codes using encoding algorithms. In one example, the interface codes include text that is either associated with or derived from the graphical user interface, for example, using OCR techniques, or the like. However, this is not essential and other techniques could be used, such as pattern matching, feature identification, or the like.

In one example, the method includes determining a region position indicative of a position of the region and determining an interaction position using the region position and the relative position. In a further example, this can also take into account at least one display attribute and determining the interaction position at least partially in accordance with the display attribute, for example, to take into account scaling, display resolution, or the like.

The method can include identifying a plurality of regions, with each region corresponding to a respective selected region, and then performing a respective sequence of one or more user interactions relative to each of the plurality of regions. As previously outlined, this can help assist in ensuring interactions are performed accurately, for example, allowing interactions to be performed relative to a local region of the interface, as well as allowing sequences of interactions to be used independently and/or in different combinations.

In one example, the graphical user interface is rendered by a software application in accordance with data received from a remote computer system. The graphical user interface can be rendered by a first software application executed by the computer system, with the method, and in particular execution of the instructions, being performed at least in part using a second software application executed by the computer system. The method can be performed using a JAVA run-time application with python libraries being used for performing image recognition and with the graphical user interface being implemented by a web browser, although this is not essential and other arrangements can be used.

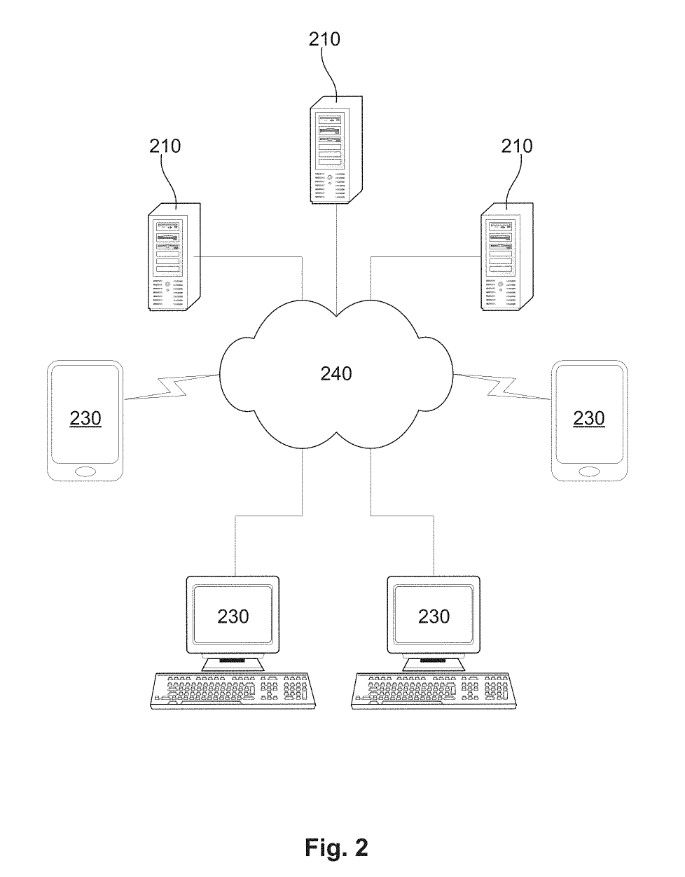

In one example, the process is performed by one or more processing systems operating as part of a distributed architecture, an example of which will now be described with reference to FIG. 2.

In this example, a number of processing systems 210 are provided coupled to one or more computer systems 230, via one or more communications networks 240, such as the Internet, and/or a number of local area networks (LANs).

Any number of processing systems 210 and computer system 230 could be provided, and the current representation is for the purpose of illustration only. The configuration of the communications networks 240 is also for the purpose of example only, and in practice the processing systems 210 and computer systems 230 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like.

In this example, the processing systems 210 are adapted to provide services accessed via an interface displayed via the computer systems 230. Whilst the processing systems 210 are shown as single entities, it will be appreciated they could include a number of processing systems distributed over a number of geographically separate locations, for example as part of a cloud based environment. Thus, the above described arrangements are not essential and other suitable configurations could be used.

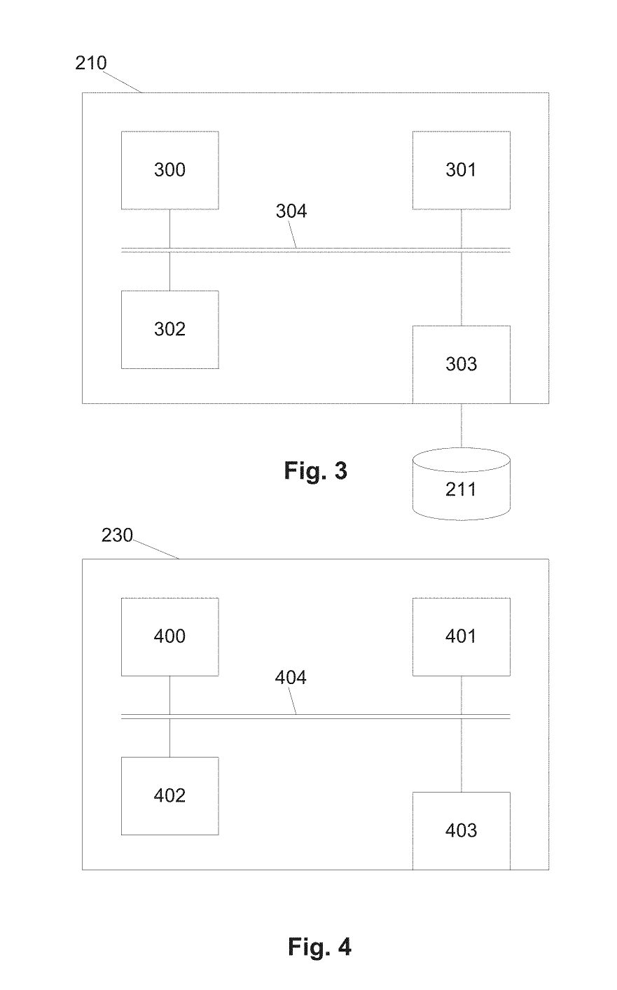

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304, as shown. In this example, the external interface 303 can be utilised for connecting the processing system 210 to peripheral devices, such as the computer system 230, databases 211, other storage devices, or the like. Although a single external interface 303 is shown, this is for the purpose of example only, and in practice multiple interfaces using various methods (e.g., Ethernet, serial, USB, wireless, or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing system 210 may be formed from any suitable processing system, such as a suitably programmed PC, web server, network server, or the like. In one particular example, the processing system 210 is a standard processing system, such as an Intel Architecture based processing system, which executes software applications stored on non-volatile (e.g., hard disk) storage, although this is not essential. However, it will also be understood that the processing system could be any electronic processing device, such as a microprocessor, microchip processor, logic gate configuration, firmware optionally associated with implementing logic such as an FPGA (Field Programmable Gate Array), or any other electronic device, system or arrangement.

As shown in FIG. 4, in one example, the computer system 230 includes at least one microprocessor 400, a memory 401, an input/output device 402, such as a keyboard and/or display, an external interface 403, and typically a card reader, interconnected via a bus 404, as shown. In this example the external interface 403 can be utilised for connecting the transaction terminal 220 to peripheral devices, such as the computer system 230 databases, other storage devices, or the like. Although a single external interface 403 is shown, this is for the purpose of example only, and in practice multiple interfaces using various methods (e.g., Ethernet, serial, USB, wireless or the like) may be provided. The card reader can be of any suitable form and could include a magnetic card reader, or contactless reader for reading smartcards, or the like.

In use, the microprocessor 400 executes instructions in the form of applications software stored in the memory 401, and allows communication with one of the processing systems 210.

Accordingly, it will be appreciated that the computer system 230 is formed from any suitably programmed processing system and could include suitably programmed PCs, Internet terminal, lap-top, or hand-held PC, a tablet, a smart phone, or the like. However, it will also be understood that the computer system 230 can be any electronic processing device, such as a microprocessor, microchip processor, logic gate configuration, firmware optionally associated with implementing logic such as an FPGA (Field Programmable Gate Array), or any other electronic device, system or arrangement.

Examples of the processes for generating and executing instructions will now be described in further detail. For the purpose of these examples, it is assumed that one or more respective processing systems 210 are servers that host services accessed via a user interface. The processing systems 210 typically execute processing device software, allowing relevant actions to be performed, with actions performed by the processing systems 210 being performed by the processor 300 in accordance with instructions stored as applications software in the memory 301 and/or input commands received from a user via the I/O device 302. It will also be assumed that actions performed by the computer systems 230, are performed by the processor 400 in accordance with instructions stored as applications software in the memory 401 and/or input commands received from a user via the I/O device 402.

However, it will be appreciated that the above described configuration assumed for the purpose of the following examples is not essential, and numerous other configurations may be used. It will also be appreciated that the partitioning of functionality between the different processing systems may vary, depending on the particular implementation.

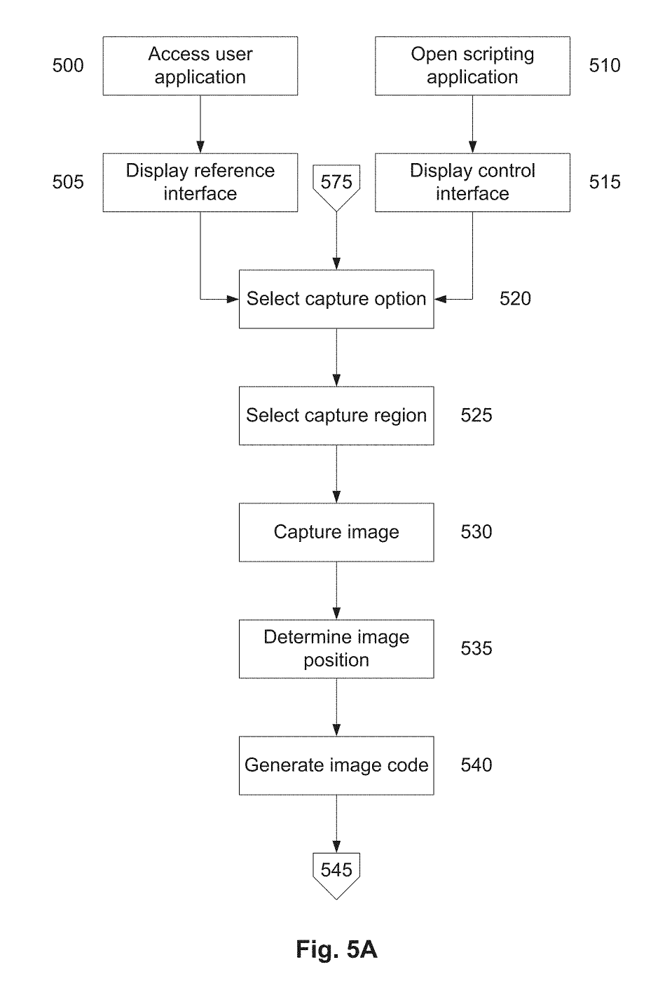

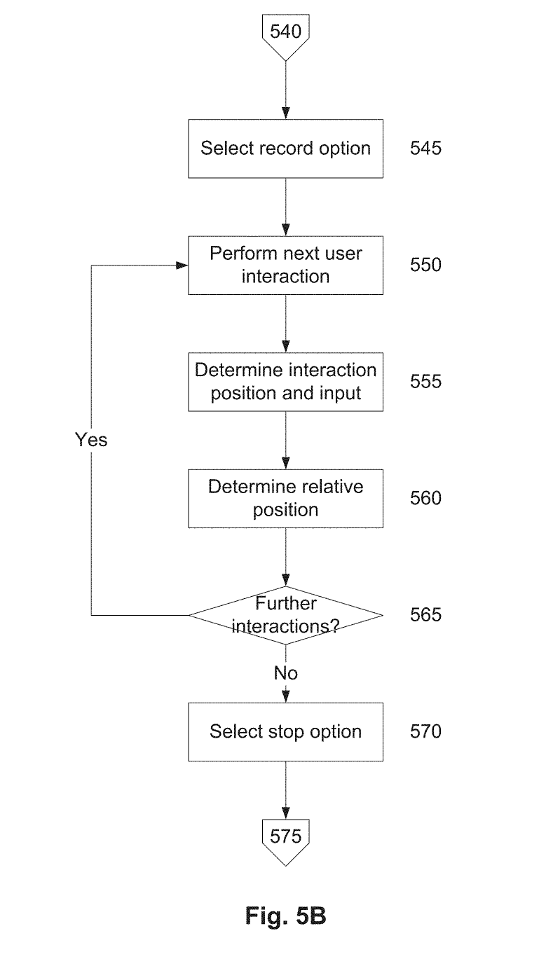

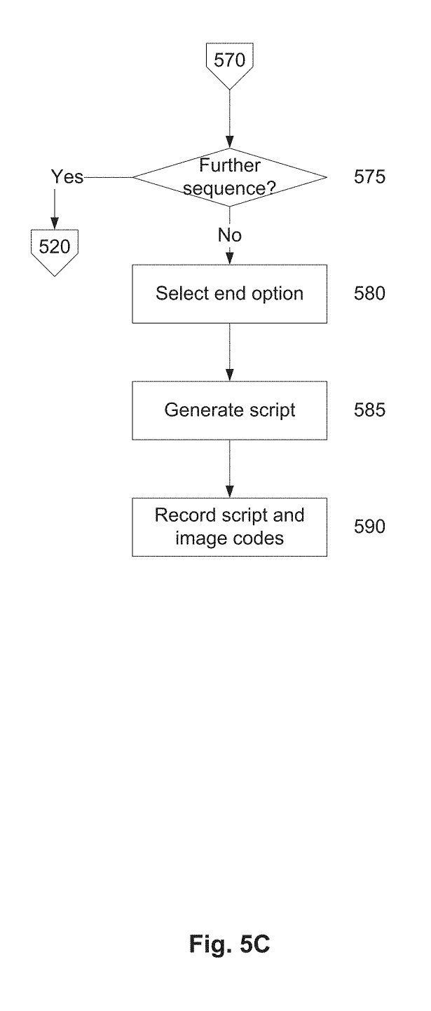

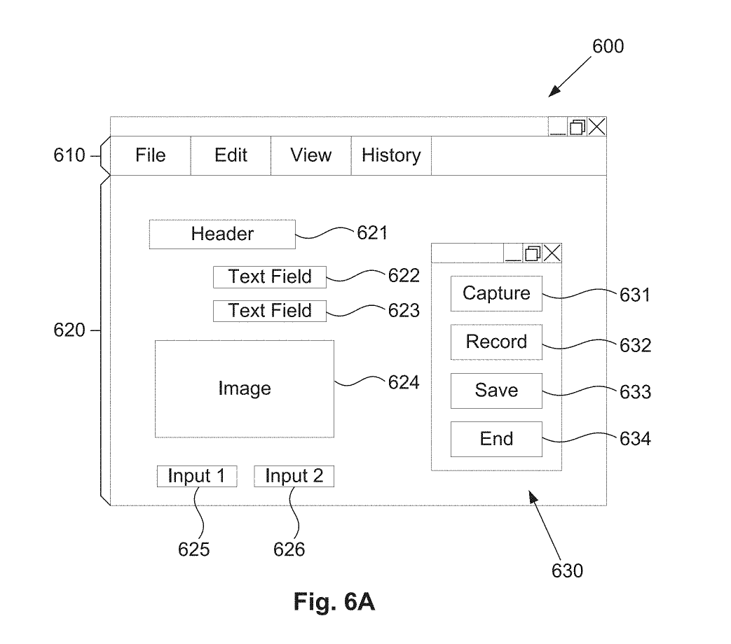

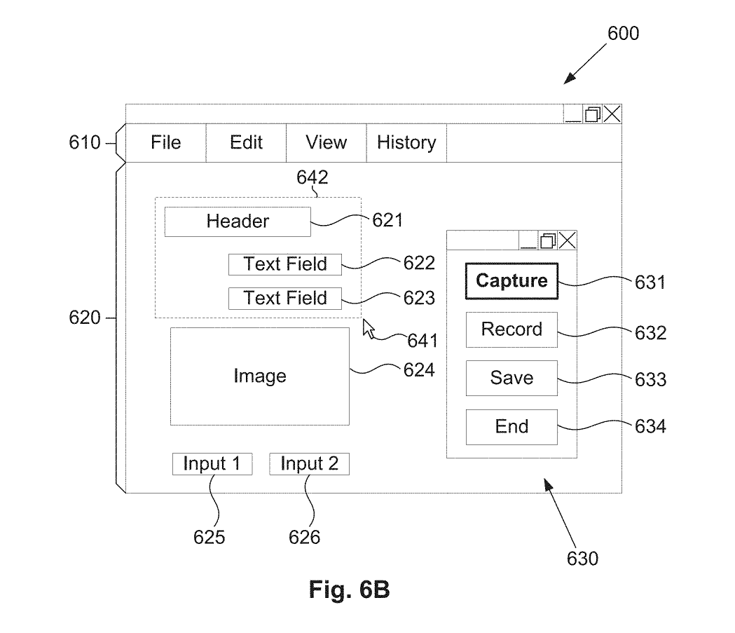

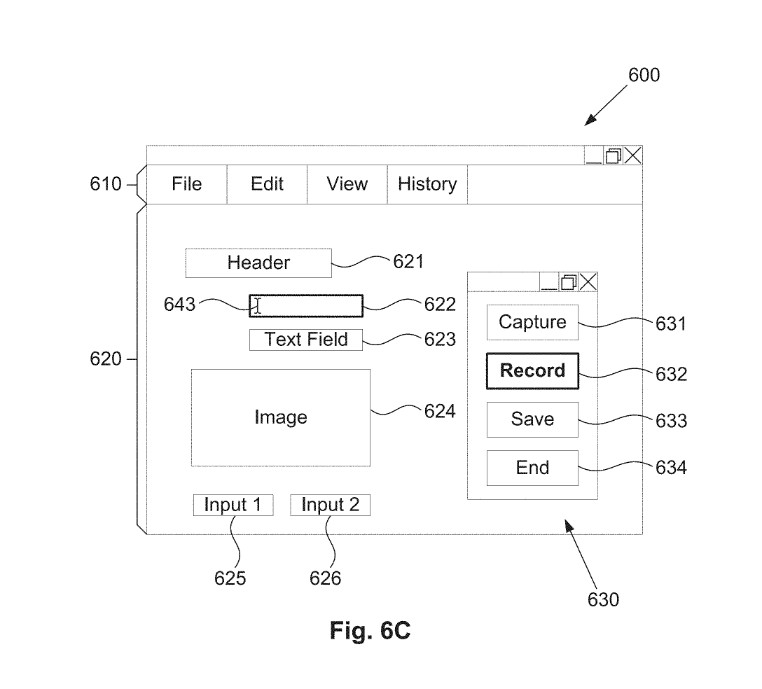

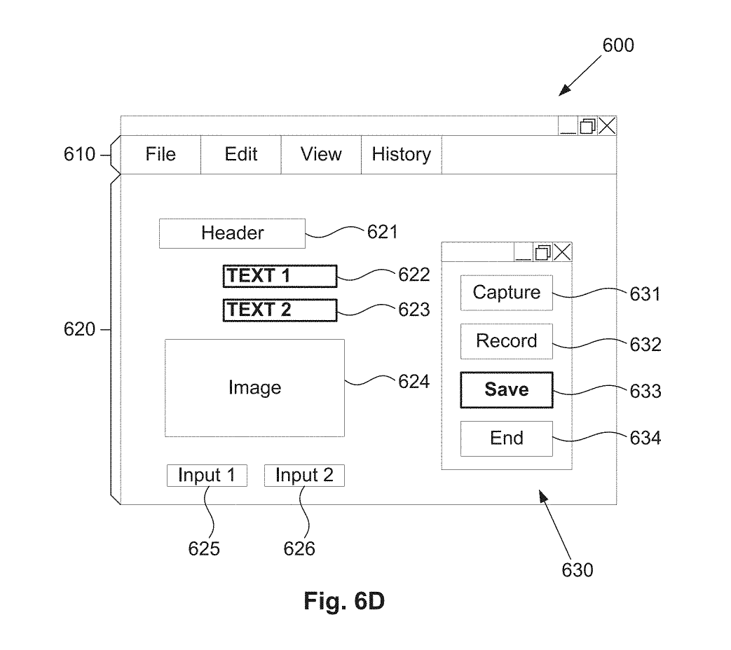

A further example process will now be described in more detail with reference to FIGS. 5A to 5C and 6A to 6D.

In this example, at step 500, the computer system 230 accesses an application, such as a web browser, which then operates to display a reference interface at step 505. As previously described, the reference interface is a reference instance of a graphical user interface displayed by the user application and could be in the form of an interface for the respective user application, and/or an interface to a remote processing system 210 displayed via a suitable application such as a browser application, or the like. Concurrently, before or after, at step 510 the computer system 230 executes a scripting application for generating executable instructions in the form of a script, and displays a respective control interface at step 515.

Examples of the user and control interfaces are shown in FIG. 6A. In particular, in FIG. 6A a typical browser application interface 600 is shown including a menu bar 610 with associated controls for the user application. The user interface 600 includes a window 620, such as a browser window, which displays the user interface. The user interface includes a number of interface elements including a header 621, text fields 622, 623, an image 624 and input buttons 625, 626.

In addition to this, the control interface 630 is displayed, which may be in the form of a pop-up box, or the like. The control interface 630 includes a number of control input options in the form of respective buttons, in this example, including a capture button 631, a record button 632, a save button 633 and an end button 634.

When the user wishes to record a script, the user initially selects a capture option at step 520 triggering an image capture process. In this regard, once the capture button 631 is selected, a pointer 641, or the like, can be displayed, allowing the user to drag the pointer 641 so as to select an image capture region 642, at step 525. In this example the image capture region encompasses the header box 621 as well as text fields 622, 623. Having selected a capture region at step 525, the computer system 230 captures an image of the respective region at step 530 and determines an image position at step 535, for example, in the form of coordinates of one or more corners of the image, a particular part of the image, such as the top left hand corner, an edge of a graphical element, or the like.

At step 540, the image is encoded utilising an encoding process to generate an image code. The image code could be of any appropriate form and could be indicative of particular graphical elements contained within the image, could be an OCR of text within the image, could be a feature set indicative of particular objects and/or colours, shapes of interface elements, or the like.

At step 545, having captured the image, the user selects a record option, by selecting the record input button 632, as shown in FIG. 6C. Having selected the record option, the user commences performing a next user interaction at step 550. In the example shown, the user has selected to enter text into the text field 622, as shown by the cursor 643.

At step 555, the computer system 230 determines an absolute interaction position and then particular interaction input is provided, such as the text entered, before determining a relative position of the interaction at step 560. In particular, the relative position is determined with respect to the absolute position of the captured image.

At step 565, it is determined if further interactions are to be performed and if so, the process returns to step 550, otherwise, assuming the user selects a save option at step 570, the computer system determines if a further sequence is to be captured at step 575 based on user input. For example, having selected the save input button 633, the user could select a capture button 631 and capture an alternative image, for example, incorporating the image 624 and the input buttons 625, 626. The process can then be repeated to capture further user interactions, such as selection of one or more of the input buttons 625, 626.

It will be appreciated from this that the process can be repeated allowing multiple different images to be captured with respective sequences of user interactions being recorded relative to each captured image.

Once all sequences have been captured, the user selects the end input button 634 at step 580, causing the computer system to automatically generate a script encompassing the sequence of user interactions at step 585. The script is then recorded associated with the respective image codes at step 590.

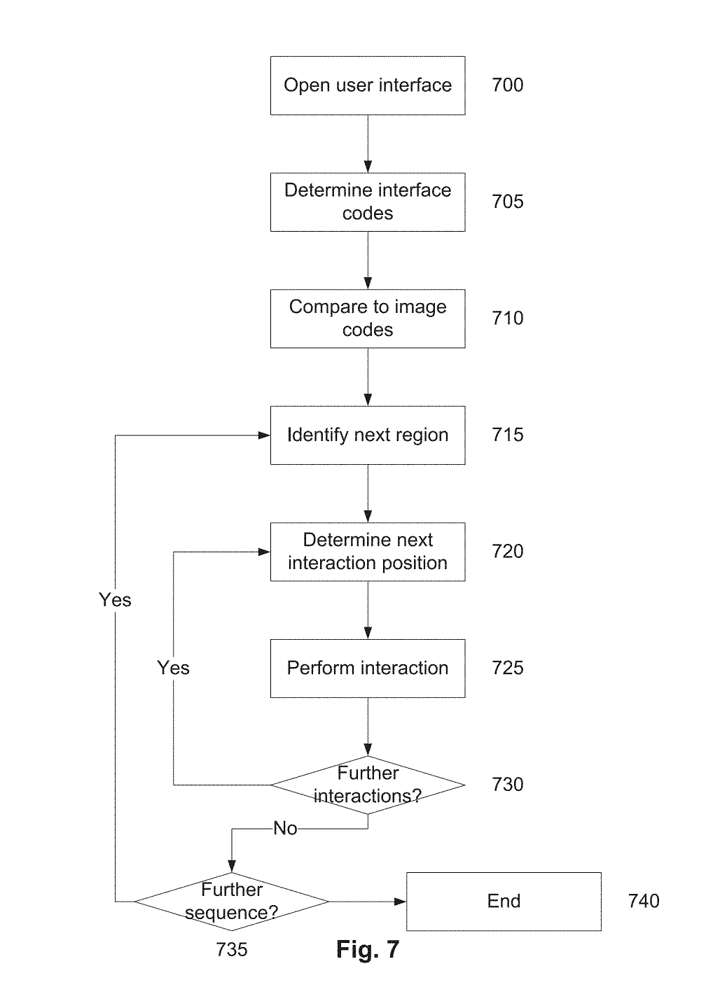

An example of the process for performing the instructions will now be described with reference to FIG. 7.

In this example, at step 700 the computer system opens the user interface. In this regard it would typically be necessary for the user application executed by the computer system to internally generate, but not necessarily display, the interface. The generating step ensures the positions of images and input elements can be appropriately determined.

At step 705, the computer system 230 determines interface codes by encoding the user interface using the encoding algorithm. Thus, this will typically operate to generate codes indicative of graphical elements and/or text, with the generated codes being compared to the image codes at step 710, allowing a next region to be identified at step 715.

The comparison process can be a direct match process or alternatively utilise matching techniques, such as fuzzy logic, partial matching, or the like, in order to identify close but non-exact matches, for example, arising due to errors in the encoding process.

Having identified the next region at step 715, the computer system determines a next interaction position at step 720, based on the relative position of a corresponding user interaction. The computer system then performs the interaction at step 725, before determining if further interactions are to be performed in respective sequence at step 730. If so, steps 720 to 730 are repeated until the particular sequence has been completed at which time it is determined if further sequences of interactions are to be performed at step 735. If so, a next region is identified at step 715 with the process being repeated until all user interactions are complete, at which point the process can end at step 740.

Specific features of an example implementation will now be described.

In one example, the system is implemented using Python Libraries for image recognition. When a captured image is loaded, the image is converted to an image code in the form of a text document. When the software application is running to execute the script, the current user interface screen is always captured and converted to interface codes in the form of text. The user interface codes can be mapped to images codes derived from the captured image to determine if there is a match. Whenever a match is found, the location of the captured image and the corresponding coordinates on the interface can be determined.

Perl Libraries are used to do a data mapping of the text that is being converted. This can be used to perform closest matches and patterns available. In one example, this is used to determine a percentage indicative of the likelihood of a captured image being present in the user interface. A threshold can then be set to allow a match to be determined.

Jython libraries can be used to support the python libraries on a Java runtime. This acts as a bridge to execute all the python functionalities and use capabilities on Java. This arrangement also assists in communicating with the other programs that are running on the environment.

Java is used as a container to run all the Jython related image recognition code and also is a stable and platform independent runtime environment to use. This can be used to write jars that communicate to different databases using standard connection strings to validate and perform actions related to databases. This arrangement can also be used to build http layers to utilize or test web services and initiate any remote calls for process level executions. It communicates with other services running on the machine using its existing libraries and also to the internet for any remote communications.

In one example, VB.Net is primarily used to build the UI for the user to interact with the JAVA runtime. The control interface provides functionalities, including all the keyboard and mouse based interactions. Interaction with core windows shell to communicate to remote hosts and auto trigger tasks. ADO.Net can be used for all user interface interactions with the programs that are system services and core application packages. In one example, this is used to build all the Microsoft® office products for reading and writing excel sheets and word documents for documentation purposes.

Windows Core DLL's can be used primarily to move the mouse to a particular location or initiate commands from the keyboard without real user interaction. Windows services are created as a communication channel between different languages, like JAVA to VB.Net or JAVA to Scripts.

Accordingly, it will be appreciated that the above described system provides a mechanism to allow users to easily generate computer executable instructions in the form of scripts. The system can allow users to capture images of regions of a user interface, and then record interactions relative to the position of the captured images. When instructions are executed, the computer system searches a user interface to identify regions equivalent to the captured image, and then performs interactions equivalent to the recorded user interactions at locations defined relative to the identified regions. This provides a mechanism to allow unskilled users to readily define scripts without requiring specific programming expertise.

It will also be appreciated that individual sequences of interactions can be implemented as sub tasks, so that different sequences could be implemented, for example, depending on the outcome of previous interactions.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the disclosure broadly appearing before described.

With that said, and as described, it should be appreciated that one or more aspects of the present disclosure transform a general-purpose computing device (or computer or computer system) into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for generating computer executable instructions to allow computer interaction with a graphical user interface, the method comprising:
displaying, by a computer system, a reference interface, the reference interface being a reference instance of the graphical user interface;
capturing, by the computer system, an image of a selected region of the reference interface;
recording, by the computer system, a sequence of one or more user interactions with the reference interface based on a relative position of each user interaction with respect to the selected region; and
generating, by the computer system, computer executable instructions defining the sequence of user interactions in accordance with the respective relative position of each user interaction.

2. The method according to claim 1, further comprising determining the selected region in accordance with user input commands.

3. The method according to claim 1, further comprising:
determining a selected region position indicative of a position of the selected region; and
determining the relative position of each user interaction at least partially in accordance with the selected region position.

4. The method according to claim 1, further comprising:
determining a user interaction with the user interface in accordance with user input commands;
determining a user interaction position indicative of a position of the user interaction on the user interface; and
determining the relative position of each user interaction at least partially in accordance with the user interaction position.

5. The method according to claim 1, further comprising determining a relative position of each user interaction based on a user interaction position and a selected region position.

6. The method according to claim 1, further comprising:
capturing a plurality of images, each image being of a respective selected region; and
recording a plurality of sequences of one or more user interactions, the user interactions of each sequence being recorded based on a relative position of the user interactions with respect to a respective one of the selected regions.

7. The method according to claim 1, further comprising:
determining an image code indicative of the captured image;
associating the image code with the computer executable instructions; and
converting the image to the image code using an encoding algorithm, the image code including text associated with or derived from the image, the text being determined using OCR techniques.

8.-10. (canceled)

11. The method according to claim 1, further comprising:
determining at least one display attribute; and
generating the executable instructions at least partially in accordance with the display attribute.

12. The method according to claim 1, wherein the reference interface is rendered by a software application at least partially in accordance with data received from a remote computer system; and/or
wherein the reference interface is rendered by a first software application executed by the computer system and wherein the method is performed using a second software application executed by the computer system, the second software application displaying a control user interface, the method further being performed at least in part using input commands received via the control user interface.

13.-14. (canceled)

15. The method according to claim 1, wherein the method is performed at least in part using a JAVA runtime application, performed using python libraries to performed image recognition, and the reference interface being rendered by a web browser.

16.-17. (canceled)

18. An apparatus for generating computer executable instructions to allow computer interaction with a graphical user interface, the apparatus including a computer system configured:
display a reference interface;
capture an image of a selected region of the reference interface;
record a sequence of one or more user interactions with the reference interface based on a relative position of each user interaction with respect to the selected region; and
generate computer executable instructions defining the sequence of user interactions in accordance with the respective relative position of each user interaction.

19. The apparatus according to claim 18, wherein the computer system includes:
a display that displays the user interaction; and
components for generating computer executable instructions to allow computer interaction with a graphical user interface.

20. A method for computer interaction with a graphical user interface, the method comprising:
accessing, by a computer system, the user interface;
identifying, by the computer system, a region of the graphical user interface corresponding to a selected region of a reference interface at least in part using a captured image of the selected region and image recognition techniques; and
performing, by the computer system, a sequence of one or more computer interactions with the graphical user interface in accordance with computer executable instructions, the computer executable instructions defining a sequence of one or more user interactions recorded based on a relative position of each user interaction with respect to the selected region of the reference interface, each computer interaction being performed relative to the identified region using the respective relative position of a corresponding user interaction.

21. The method according to claim 20, wherein identifying the region of the graphical user interface includes OAT
comparing the graphical user interface to an image code indicative of the captured image; and
identifying the region in accordance with results of the comparison.

22. The method according to claim 21, further comprising:
converting the graphical user interface into interface codes;
comparing the interface codes to the image code;
identifying the region in accordance with results of the comparison;
comparing the interface codes and the image code using pattern matching techniques; and
converting the user interface into interface codes using an encoding algorithm, the interface codes including text associated with or derived from the graphical user interface, the text being determined using OCR techniques.

23.-26. (canceled)

27. The method according to claim 20, further comprising:
determining a region position indicative of a position of the region; and
determining an interaction position using the region position and the relative position.

28. The method according to claim 20, further comprising:
determining at least one display attribute; and
determining the interaction position at least partially in accordance with the display attribute.

29. The method according to claim 20, wherein the method includes:
identifying a plurality of regions, each region corresponding to a respective selected region; and
performing a sequence of one or more user interactions relative to each of the plurality of regions.

30. The method according to claim 20, wherein the graphical user interface is rendered by a software application at least partially in accordance with data received from a remote computer system; or
wherein the graphical user interface is rendered by a first software application executed by the computer system and wherein the method is performed using a second software application executed by the computer system.

31. (canceled)

32. The method according to claim 20, wherein the method is performed at least in part using a JAVA runtime application, performed using python libraries to performed image recognition, and the graphical user interface is rendered by a web browser.

33.-37. (canceled)
